(19) United States
(12) Patent Application Publication
(10) Pub. No.: US 2008/0298056 A1
(43) Pub. Date: Dec. 4, 2008

(54) LIGHT FIXTURE WITH REPLACEABLE OPTICS

(75) Inventor: Morten PETERSEN, Randers (DK)

Correspondence Address: ROBERTS MLOTKOWSKI SAFRAN & COLE, P.C.;Intellectual Property Department, P.O. Box 10064, MCLEAN, VA, 22102-8064, US

(73) Assignee: MARTIN PROFESSIONAL A/S, Aarhus N (DK)

(21) Appl. No.: 12/128,818

(22) Filed: May 29, 2008

(30) Foreign Application Priority Data
May 29, 2007 (DK) PA 2007 00768

(51) Int. Cl. F21V 1/00; F21V 11/00; F21V 17/04

(52) U.S. Cl. 362/235; 362/293; 362/433

(57) ABSTRACT

The present invention concerns a method for replacing optical elements and a light fixture containing at least one light source for illumination, including a system for fastening and replacing at least one optical element by means of magnetic attachment. It is the purpose of the invention to achieve rapid replacement of optical components in connection with a light fixture. Another purpose is that this replacement may occur without using tools and without the operator interfering with the preload of the fastening. The purpose may be achieved by a light fixture, if the optical element and the light fixture include at least two interacting magnetic interlocking pairs, the interlocking pairs including at least one permanent magnet, where at least the permanent magnet of the interlocking pair is disposed in a magnetically non-conducting material. Hereby it becomes possible for an operator to replace optical components in a very large number of light fixtures rapidly and without risking damage to the components.

### BACKGROUND OF THE INVENTION

1. Field of the Invention

The present invention concerns a light fixture containing at least one light source for illuminating objects or rooms, including a system for fastening and replacing at least one optical element by means of magnetic attachment.

The present invention also concerns a method for fastening and replacing an optical element in a light fixture.

2. Description of Related Art

It is well-known that the characteristic of a light beam, e.g. diffusing angle or angle of divergence, is changed if an optical component in the light path is changed. This phenomenon is now as well as previously used in light fixtures for entertainment and architectural illumination. Today there are light fixtures which are automated and which may be remotely controlled, which means that optical components can be replaced by means of electro-mechanics and controllers. Many light fixtures are, however, still fully manual or partly manual, in particular in areas that do not require regular changes.

An example of such an area is output lenses on a light fixture. These will often determine the angle of divergence of the product, but it is not a component that will be changed very often. Such lenses are therefore often screwed on, either directly into the lens material or fastened under leaf or compression springs. If the lens is not intended to be replaced, it is often glued into the light fixture. Optical components are typically made of either glass or resin (e.g. acrylic plastic). Acrylic plastic is often used as substitution for glass, as it has very good optical properties, weighs less and is easier and cheaper to mould and machine. However, both glass and acrylic plastic are very brittle and notch-sensitive, causing them to crack very easily when subjected to various physical and chemical actions in combination with stresses in the material. In order to avoid this it is to be provided that inadvertent stresses cannot be applied to the material. For example, a direct screw fastening will almost always mean failure as the torque applied to the screw may only be controlled by means of special tools. An end user of a light fixture will probably not have such a tool, and replacing the component will most likely result in the new component being mounted with too large torque, and that the new component will crack sooner or later, possibly in combination with other influences, such as heat or cold. The most common way of solving this problem is to glue the optical component in the light fixture, or to glue the optical component on a metal sheet which is then screwed on the light fixture. Another solution is to use compression or leaf springs to keep the component in place, whereby a predefined preload is provided.

Another aspect is the desire to replace the component quickly, and that the component is to be aligned precisely so that optical disturbances do not occur after replacement. This has again appeared with leaf springs and various kinds of guides, but a more sophisticated solution has appeared with using magnetic locking as in:

WO 98/10220 discloses a light apparatus, in particular for dental applications. A light filter for dental applications provided with a transparent plane element which is coloured for filtering off visible light in the area between 400 nm to 520 nm, which is the range in which light hardened materials for dental use are sensitive. A lower part of a magnetic material fastened to the lower side of the plane element and a fastener with an outer shell of a magnetic material containing a permanent magnet, the fastener being secured to the lens.

U.S. Pat. No. 4,199,885 discloses a sign that may be illuminated, including a panel with an opening therein. A lens design including at least one magnetic element in its outer circumference may be mounted in the opening from the front side of the panel. The lens construction is detachably secured in the opening via one or more permanent magnets mounted at the side of the opening at the rear side of the panel, which attracts the magnetic element or elements.

U.S. Pat. No. 7,222,997/U.S. Pat. No. 6,971,770 disclose an optical component, e.g. a colour wheel for light fixture with a guide formation, such as an opening engaging a complementary guide formation, such as a projection on an iron-containing drive wheel. The drive wheel engages the rotary part via a magnetic lock.

U.S. Pat. No. 2,953,970 concerns magnetic fastening of optical components in the form of spacer rings for a camera or fastening of e.g. lens hoods on camera lenses.

U.S. Pat. No. 3,593,021 concerns a light fixture including an annular support element with an adhesive back lining and an opposite surface formed of a magnetic material. The support element is concentrically perforated in order to provide rings with stepped diameters. The rings are each moved in order to provide an aperture with a predetermined diameter through the support element for localising and aligning the latter around light fixtures with different diameters. The support element is adhesively secured to the wall or the ceiling surface around and independently of the light fixture. A light diffuser with an inwards directed flange at the side of its open end and incorporating a number of magnets on the flange is used around the support element so that the light diffuser is magnetically secured to the support element. In another form, the magnetic materials are provided on the light diffuser flange with the magnets that are secured to the support element.

### OBJECTS OF THE INVENTION

It is the purpose of the invention to achieve rapid replacement of optical components in connection with a light fixture. Another purpose is that this replacement may occur without using tools and without the operator possibly interfering with the preload of the fastening.

### DESCRIPTION OF THE INVENTION

The purpose may be achieved by a light fixture as specified in the preamble of claim 1, if the optical element and the light fixture include at least two interacting magnetic interlocking pairs, the interlocking pairs including at least one permanent magnet, where at least the permanent magnet of the interlocking pair is disposed in a magnetically non-conducting material.

The first advantage achieved by this invention is a solution which combines rapid replacement of an optical component without use of tools and a fastening which is not dependent on the operator's handling. Hereby it becomes possible for an operator to rapidly replace optical components in a very large number of light fixtures. This is particularly expedient if a large number of light fixtures are e.g. assembled into an entire wall. Thereby it may be necessary to replace the optical components in the very large number of light fixtures in order to change optical properties of the entire wall. It is particularly expedient here that this replacement can be effected without any use of tools at all.

The magnetic interlocking pairs may be designed with uniform geometries on their contact faces. The uniform geometry on the contact faces mean that the magnetic components in the magnetic locks are automatically attracted and locked on each other. The simplest geometry would be a plane surface ensuring a stable abutment and which in most cases is sufficient, provided that the magnetic force is sufficiently large. By an alternative embodiment, other geometries on the abutment surfaces may be envisioned. This is feasible as long as these geometries interact. By using various locks, it becomes possible in principle to achieve self-alignment, if e.g. the geometry on the contact faces are designed with inclination so that the optical components are automatically aligned to the correct position.

The optical element may be designed with at least one transparent lens structure which changes the characteristic of the light source with regard to angle of divergence. On the fact that a light source most frequently is made with a constant angle of divergence or diffusing, it is often suitable to be able to change this angle of divergence by replacing an optical component in an efficient way. By the present invention it thus becomes possible to change an angle of divergence for an entire optical wall by simply substituting each optical component with a component having just the angle of divergence wanted for the application for the entire wall.

The first member of the magnetic locking pair may be secured to the optical element, and the second member is a spacer stay which is secured to the light fixture. By means of the spacer stays, the optical element is lifted up above the light source/sources itself/themselves, and by disposing either a magnet or some magnetising material at the top of the stays, it is achieved that an optical element can be fastened to the top of one or more stays, thereby securely disposing the optical element at the correct distance from a light source, and where the magnetic attachment simultaneously ensure that the optical element remains at its position, even if vibrations occur or if a light fixture is moved.

The light source may consist of one or more LEDs (Light Emitting Diodes). A preferred light source would be LED, but other light sources may also be used. It is probable that in the future completely new light sources will appear which may replace LEDs, and the LEDs known today will go through a profound further development. By a plurality of LEDs it will be possible to produce light with variable colours as one may control the light emission from the individual light diodes so that it becomes possible to produce arbitrary colours within a colour spectrum.

The LEDs may be controlled by a controller, the controller regulating current and/or voltage for the LEDs. By using a controller for controlling the LEDs, the desired colour may be achieved from a control signal supplied to the controller. The controller may e.g. provide pulse width modulation of the LEDs in order to achieve an efficient colour mixing.

The optical element and the light fixture may advantageously include a coding that may prevent incorrect disposition of the optical element, where the coding consists of interacting magnets. In order to avoid incorrect disposition of an optical element, one may e.g. place North Pole and South Pole facing magnets alternatingly so that each of the interlocking pairs consists of two magnets that interact by attraction of opposite polarity. By incorrect disposition of an optical element, an opposing force may be achieved which changes the incorrect position if the magnets are facing e.g. with north pole against north pole. Hereby a very efficient coding may be achieved so that possible incorrect disposition of the optical elements is nearly impossible.

The spacer stay of the light fixture may be designed with a projecting contact face, the contact face interacting with at least one projection on the optical element. By designing the optical element with one or more projections it becomes possible to achieve a mechanical securing of the correct position of the optical element in relation to the stays.

The invention also concerns a method for fastening and replacing an optical element in a light fixture, where the optical element and the light fixture may contain each their half part of at least two magnetic interlocking pairs, wherein at least one of the parts is a permanent magnet, and where at least the permanent magnets of the interlocking pairs may be surrounded by magnetically non-conducting material. Hereby it becomes possible to replace optical elements in light fixtures without using any tools. As already mentioned above, this is a tremendous advantage if optical elements are to be replaced in an entire light wall.

### DESCRIPTION OF THE DRAWINGS

FIG. 1 shows a first embodiment of a light fixture according to the invention;

FIG. 2 shows an enlarged view of an end section of a light fixture;

FIG. 3 shows a section through a printed circuit board (PCB) with light sources and an optical element;

FIG. 4 shows a spatial view of an optical element and a printed circuit board;

FIG. 5 shows a section along line B-B in FIG. 6 through a printed circuit board and an optical element; and

FIG. 6 is a front view of an optical element.

### DETAILED DESCRIPTION OF THE INVENTION

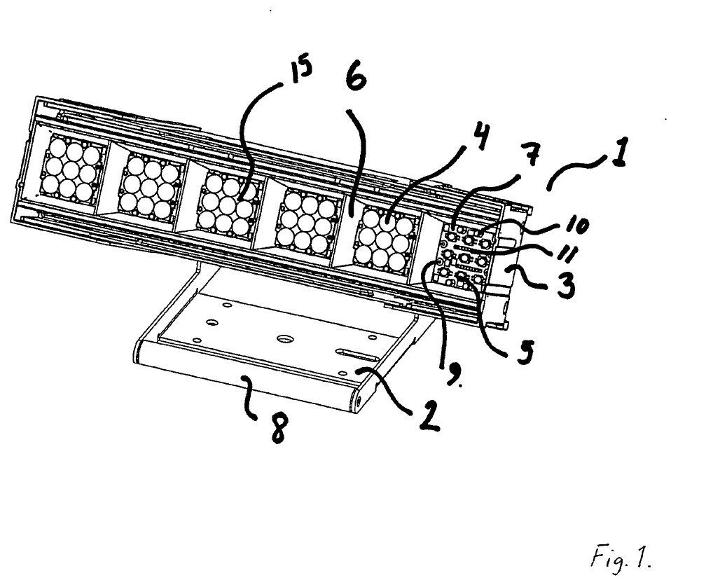

FIG. 1 shows a light fixture 1 provided on a base 2. The base 2 is shown with a handle 8. The light fixture 1 is built into a chassis 3 which in the shown embodiment divides the light fixture into six cells, each cell containing an optical element 4 including a number of lenses for disposition above light sources 5, which are shown in the first cell where the optical element 4 is removed. The individual cells in the chassis 3 are separated by means of reflectors 6. In the first cell of the chassis 3 there is shown a light source PCB 7 containing light sources and electronic components in connection with activation of the light sources 5. The light source PCB 7 is fastened by means of mounting screws 9. The light source PCB 7 also contains spacer stays 10, and an assembly point 11 is shown.

By a light fixture 1 equipped with a number of cells it is possible to regulate the light sources 5 in a way so that every cell may emit light of a different colour. The building together of a number of light fixtures 1 would be a possibility, and thus there may be constructed an entire wall by means of interconnection of a large number of light fixtures 1.

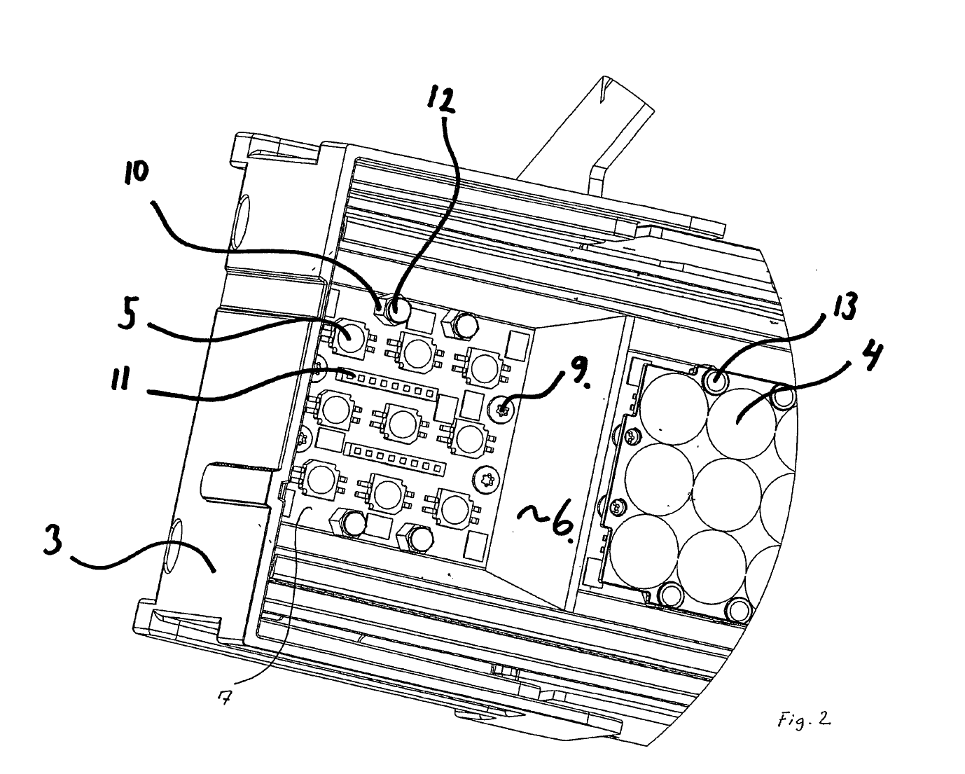

FIG. 2 shows an enlarged view of a single cell of a light fixture 1. In one cell the optical element 4 is removed so that access is provided to the light source 5, as well as a reflector 6 forming partitioning to the adjacent cell appears on the Figure. The light sources 5 are mounted on a light source PCB 7, where mounting screws 9 and spacer stays 10 are also shown on the PCB 7. Also, on the Figure is shown assembly points 11 which are seen from behind at the top side of the PCB 7, as the points 11 provide electric connection to an underlying PCB. The spacer stays 10 end upwards by a contact surface 12 for interlocking pairs. At the next half cell, where a reflector 4 is shown, there is also shown permanent magnets 13 that implicitly interact with an underlying stay 10 which is designed with a contact surface 12 made of a magnetically conducting material.

As there are four stays 10 with associated contact face 12 consisting of magnetically conducting material, good adherence is attained in four contact points such that the optical element 4 is secured at four points. If consideration is taken to the fact that the optical element 4 can be made of a plastic material, then the weight of the optical element 4 will be so modest that even during transport and possible moving of a light fixture 1 the optical elements 4 will remain correctly in position.

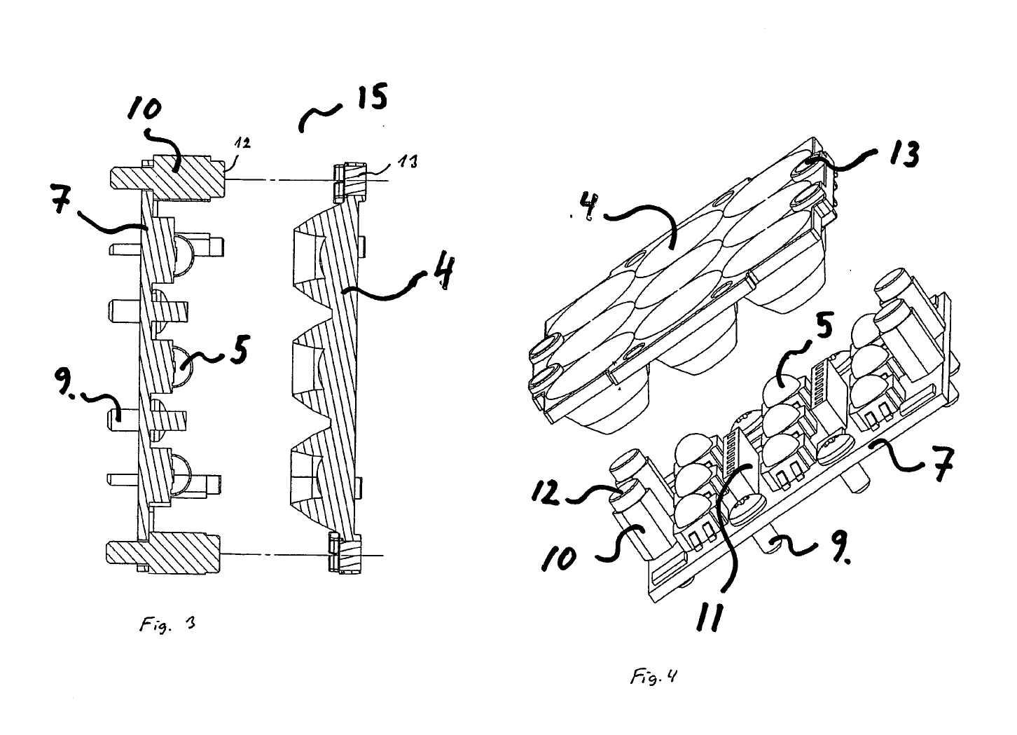

FIG. 3 shows a sectional view through a light source PCB (printed circuit board) 7 with light sources and a sectional view of an optical element 4 as well. The light source PCB 7 functions as attachment for light sources 5, and at the same time plugs 9 and spacer stays 10 are fitted on the PCB 7. The optical element 4 shows lens-shaped elements on FIG. 3 and which fit down on the light sources 5. Also, there is shown permanent magnets 13 which interact with contact faces 12 on the stays 10.

If the optical element 4 is disposed so that the contact faces 12 of the stays are provided contact with the permanent magnets 13, then the light sources 5 will be disposed very close to the lens-shaped elements, and good spreading or diffusing of the emitted light may be achieved.

FIG. 4 shows a spatial view of the same components as mentioned under FIG. 3. Thus no additional description will be provided.

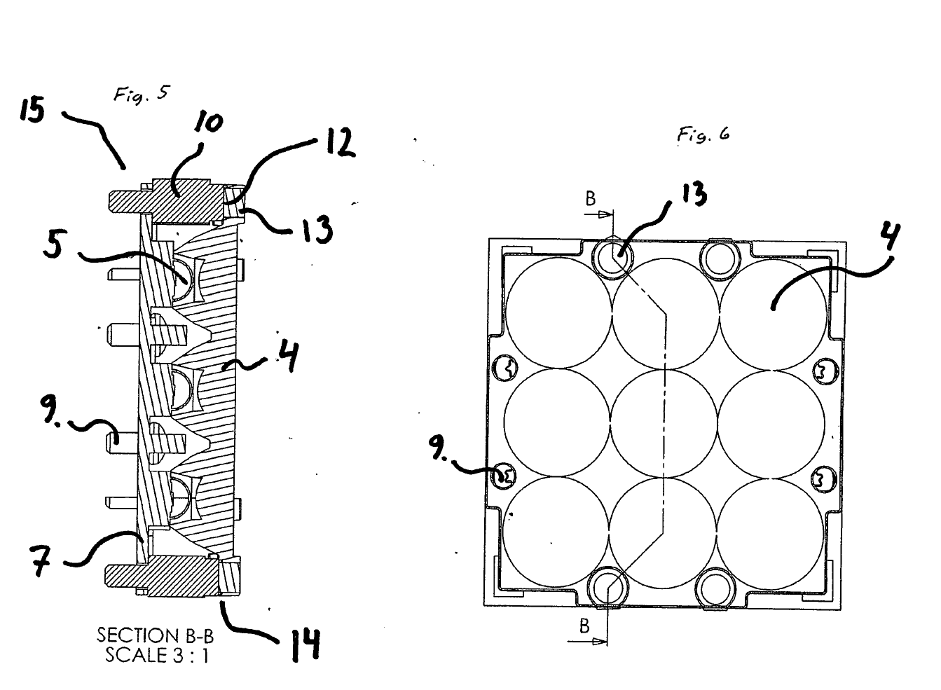

FIG. 5 shows a section along the line B-B on FIG. 6. FIG. 5 therefore shows a section through the PCB 7 and the light sources 5 which interact with the lenses disposed above and being part of the optical element 4. The stays 10 interact with a contact face 12 which in turn interacts with a permanent magnet 13. The contact face 12 at the stays 10 and the permanent magnets 13 thus form a magnetic interlocking pair 14. When the optical element 4 is disposed upon the stays 10, the optical element 15 appears.

FIG. 6 shows the optical element 4 as seen from above with permanent magnets 13, and through holes in the optical element 4 mounting screws 9 appear.

By the invention it thus becomes possible to replace the optical elements 4 very quickly, as these may be lifted free in a relatively simple way. By replacing the optical elements 4, there may be attained different diffusing or diverging angles. If a large number of light fixtures 1 are built together, e.g. to a light wall, it may be necessary to use different angles of divergence for different applications. Since it is possible to replace the optical elements 4 without any tools, it will be possible to perform relatively rapid replacement in even a large number of light fixtures and with a minimal risk of damaging the component.

The invention may be further developed, e.g. at the magnets 13 and the contact faces 12 by providing that the contact face 12 is also a magnet, whereby it may be achieved by correct polarisation of the magnets that the optical element 4 is only able to be placed in the correct position. Also, at the optical element 4 there may be provided projections that fit mechanically around the contact face 13 so that a mechanical support function is also provided, thus avoiding that the magnetic locks slide sideways. Likewise, it will also be possible to make the permanent magnets 13 with an inclining surface which is to interact with a corresponding inclining surface on contact face 12, where there may be different angles on the different contact faces 12. Thus it becomes possible to achieve an automatic aligning towards an optimal position, if more contact faces 12 interact with inclining directions, e.g. all pointing inwards, whereby the optical element 4 is automatically disposed in the entirely optimal position.

What is claimed is:

1. A light fixture including at least one light source for illuminating objects or rooms, wherein the light fixture includes a system for fastening and replacing at least one optical element by means of magnetic attachment, whereby the optical element and the light fixture include at least two interacting magnetic interlocking pairs, the interlocking pairs including at least one permanent magnet where at least the permanent magnet of the interlocking pair is disposed in a magnetically non-conducting material.

2. Light fixture according to claim 1, whereby the magnetic interlocking pairs have uniform geometries on their contact faces.

3. Light fixture according to claim 1, whereby the optical element is designed with at least one transparent lens structure which changes the characteristic of the light source with regard to angle of divergence.

4. Light fixture according to claim 2, whereby the first member of the magnetic interlocking pair is secured to the optical element, and that the second member is a spacer stay which is secured to the light fixture.

5. Light fixture according to claim 4, whereby the light source is one or more LEDs (Light Emitting Diodes).

6. Light fixture according to claim 5, whereby the LEDs may be controlled by a controller, the controller regulating current and/or voltage for the LEDs.

7. Light fixture according to claim 6, whereby the optical element and the light fixture includes a coding that prevents faulty disposition of the optical element, where the coding consists of interacting magnets.

8. Light fixture according to claim 7, whereby the spacer stay of the light fixture has a projecting contact face, which contact face interacts with at least one projection on the optical element.

9. A method for fastening and replacing an optical element in a light fixture, whereby the optical element and the light fixture contain each their half part of at least two magnetic interlocking pairs, wherein at least one of the parts is a permanent magnet, and where at least the permanent magnets of the interlocking pairs are surrounded by magnetically non-conducting material.
